(19) United States
(12) Patent Application Publication
(10) Pub. No.: US 2008/0030916 A1
(43) Pub. Date: Feb. 7, 2008

(54) Thyristor controlled alternating current demagnetizer

(76) Inventors: Elvir Kahrimanovic, Chicago, IL (US); Kenneth M. Littwin, Chicago, IL (US)

Correspondence Address: ELECTRO-MATIC PRODUCTS CO.;Attn: Robin Groth, 2235 N. Knox Ave., Chicago, IL, 60639, US

(21) Appl. No.: 11/881,619

(22) Filed: Jul. 26, 2007

Related U.S. Application Data
(60) Provisional application No. 60/833,389, filed on Jul. 26, 2006.

(51) Int. Cl. H01F 13/00

(52) U.S. Cl. 361/149

(57) ABSTRACT

This unit is intermittent duty, small, and light weight. Use of a thyristor(s) control reduces the unit's energy consumption through reduced AC input voltage while still producing sufficient demagnetizing power and effective demagnetizing results.

This principle may be applied to ANY and ALL sizes of demagnetizing coils.

With the burst control we can achieve same demagnetizing power and reduce overall power consumption of the demagnetizing coil(s) reducing size and weight of the coil(s). For this intermittent duty coil(s) the power consumption is reduced by over 40% and heating rate reduced which allows approx. 40% longer continuous running time.

### CROSS REFERENCE TO RELATED APPLICATIONS

This application claims the benefit of PPA Ser. No. 60/883,389, filed Jul. 27, 2006 by the present inventor(s).

### FEDERALLY SPONSORED RESEARCH

Not applicable

### SEQUENCE LISTING OF PROGRAM

Not applicable

### BACKGROUND OF INVENTION

1. Field of Invention

This invention relates to a microcontroller based power control, specifically to control power supplied to demagnetizing coil(s).

2. Prior Art

3. Objects and Advantages

Ferromagnetic objects are demagnetized by exposing the object(s) to alternating decaying magnetic fields.

Previously, exposure to alternating magnetic fields was accomplished by uncontrolled utility sine wave power to multi-turn coil(s) inserted in a stack of E-core laminations. The object would have to be manually passed over demagnetizing coil(s) and then moved away from the coil(s), thereby creating an alternating decaying magnetic field. The disadvantage of this method is that coil(s) have to be designed to run continuously to dissipate supplied power.

In reality, the total power needed to perform demagnetization is much lower than the power needed to power coil(s) continuously.

By sending a burst of sine wave pulses to energize demagnetizing coil(s) instead of utilizing continuous power, coil size and weight, power consumption, and heating rate are all significantly reduced, without compromising demagnetizing effect. Because objects do not have to be manually passed over demagnetizing coil(s), large objects, which were previously cumbersome, are now more practically handled.

Another disadvantage of previous technology is that object(s) can become accidentally re-magnetized if the object(s) are either incorrectly passed over the demagnetizing surface, or if power is removed from the coil(s) while object is in the magnetic field range.

This invention controls the power to the coil(s) for the completion of each burst cycle. This way the applied burst sine wave to the coil(s) will be always symmetrical, meaning that positive part of the sine wave is equal to the negative part of the sine wave. This is essential for best demagnetizing results.

### SUMMARY OF INVENTION

A microcontroller based power control sends bursts of energy in succession to demagnetizing coil(s) thereby demagnetizing ferromagnetic materials by exposing them to alternating decaying magnetic fields.

### BRIEF DESCRIPTION OF THE SEVERAL VIEWS OF THE DRAWING

FIG. 1 shows the demagnetizing coil, main printed circuit board (PCB), enclosure, cover, nameplate, and power cord.

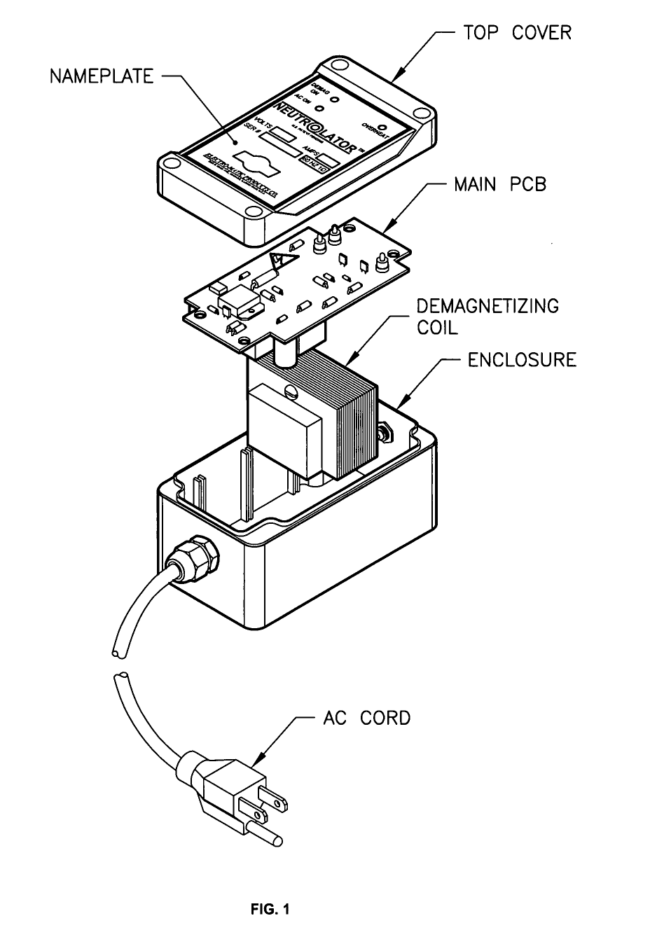

FIG. 2 shows the schematic of the Main PCB.

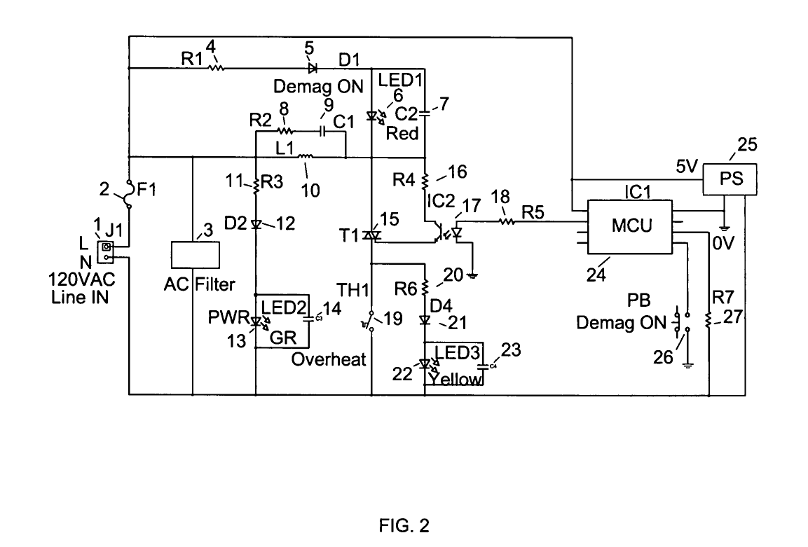

### DETAILED DESCRIPTION OF INVENTION

The system is comprised of demagnetizing coil(s) and a microcontroller based power control. The power control sends bursts of energy in succession to demagnetizing coil(s) thereby demagnetizing ferromagnetic materials by exposing them to alternating decaying magnetic fields.

Included in the microcontroller based power control are visual indicators to show present status of input power, coil energy, and temperature condition. Also included in the control are resistor(s), rectifier(s) diode(s), filter capacitor(s), optocoupler(s), fuse(s), filter(s), power supply(s) and triac(s).

### Operation of System:

Input power is fed through input line power connector at 1 protected by the fuse at 2 and filtered by AC filter at 3.

The demagnetizer has 3 different visual indicators for present input AC power indicated by green LED at 13. The power supply for this diode consists of resistor at 11, rectifier diode at 12 and filter capacitor at 14. The red LED at 6 is indicating that the demagnetizer coil(s) at 10 are energized. Power supply consists of resistor at 4, rectifier diode at 5, and filter capacitor at 7.

If the coil(s) exceed the maximum allowable temperature, the thermal switch at 19 opens and the power is being rerouted through resistor at 20, rectifier diode at 21, and filter capacitor at 23 which constitute power supply for yellow LED at 22 indicating overheating condition.

The demagnetizing coil(s) are being energized when triac at 15 conducts. Firing pulse for triac are supplied by optocoupler at 17 and current limiting resistor at 16. The driving signal for optocoupler is delivered by the microcontroller at 24 and fed through current limiting resistor at 18. Microcontroller is supplied by the non-isolated 5VDC capacitive power supply at 25.

The switching logic is created by microcontroller. By sensing the zero crossing point of the input sine wave through resistor at 27, microcontroller sends out a burst of triggering pulses to energize demagnetizing coil(s). The pulses that are used to fire triac are synchronized with incoming sine waves. This way the microcontroller can turn on the demagnetizing coil(s) at 10 exactly at zero crossing of the sine wave reducing switching, losses and improve efficiency and establish balance between positive and negative sine wave.

Length of the burst pulse depends on the demagnetizing coil(s) at 10 being used and will vary from coil to coil. The pulse has to be long enough to allow magnetic field to build up. When triac at 15 stops conducting, which corresponds to OFF time of the burst, the energy stored in the coil(s) at 10 will be transferred to the capacitor at 9. When the energy transfer is complete, the capacitor will return this energy back to the coil(s). During this process the voltage waveform applied to the coil(s) is a smooth exponentially decaying sine wave. This part of circuit is known as tank circuit.

The energy received by the capacitor at 9 is smaller then energy supplied by the coil(s) at 10. This is mainly due to resistive losses in the coil(s) and resistor at 8 which also limits inrush current of the capacitor at 9. Each time the energy transfer occurs, there is certain percentage of that energy that is lost. This is known as damping factor, meaning the energy is constantly reducing which gives us desired effect of decaying magnetic field.

Since these bursts are sent in succession, the demagnetizing process is ongoing, as long as pushbutton at 26 is depressed. If the pushbutton is released in the middle of burst ON time, microcontroller will continue to control the coil(s) until one whole burst cycle is completed. This way the applied burst sine wave to the coil(s) will be always symmetrical, meaning that positive part of the sine wave is equal to the negative part of the sine wave. This is essential for best demagnetizing results.

We claim:

1. A method of demagnetizing ferromagnetic objects.
This method is comprised of demagnetizing coil(s) and a microcontroller based power control.

2. The system of claim 1, wherein the power control sends burst(s) of energy to demagnetizer coil(s).

3. The system of claim 1, wherein microcontroller(s) control(s) the coil(s) for complete burst cycle(s) of energy.
